(19) United States
(12) Patent Application Publication
(10) Pub. No.: US 2004/0178975 A1
(43) Pub. Date: Sep. 16, 2004

(54) Method and apparatus for displaying a picture from an optical birefringence recording

(76) Inventor: George Benedict, Fremont, CA (US)

Correspondence Address: WILSON SONSINI GOODRICH & ROSATI, 650 PAGE MILL ROAD, PALO ALTO, CA, 943041050

(21) Appl. No.: 10/386,411

(22) Filed: Mar. 10, 2003

(51) Int. Cl. G09G 3/34

(52) U.S. Cl. 345/84

(57) ABSTRACT

Methods and apparatuses for displaying a picture are disclosed. Birefringent material has an optically recorded birefringence pattern, which represents a picture. A beam passing through a polarizer, the birefringent material, and another polarizer, reaches the screen, which displays the picture.

### BACKGROUND

Pictures have long been made by applying ink to paper by mechanical means controlled by electrical signals. In the years to come existing inventions in ink jet printing and new inventions such as e-paper still will also rely on the electrical manipulation of ink and some type of paper. Typically ambient light is used to display the picture with the reflection and absorption properties of the ink and paper determining the picture. Other methods of illumination may involve the light incident from the rear of and transmitted through the paper and are referred to as backlighted picture displays or light boxes.

With the advent of television and computers, the nature of the picture could be reduced to an analog or digital electrical signal. Display of these signals is typically based on flying electrons in a vacuum striking a phosphor screen. This technology is referred to as cathode ray tube or CRT and is still the predominant technology for display of pictures from electrical input signals.

More recently, pictures with improved brightness, contrast, and spatial resolution are produced by liquid crystal displays (LCDs), and laser projection displays. In this progression the displays become more complex and expensive, albeit with breath taking brilliance, detail and appeal.

In our modem age of digital information, pictures with very high spatial resolution are becoming commonplace. Although a single picture with 2K by 2K (4 million) pixels taken by a commercial digital camera is readily available; the high end commercial display of this picture can only be made by compressing the picture to the 1K by 1K range. Furthermore, commercial displays with higher resolution do not appear to be feasible in the foreseeable future; while there exist digital cameras presently available with much higher numbers of pixels, for example 8 million pixels per picture.

Another field where high resolution, contrast and brightness is of critical concern is in the display of chest, breast, and dental x-rays of patients. Whereas the interpreting physician has long relied on the x-ray film physically placed on a light box to be viewed; there is no longer a practical means to do this when the image consists of digital electrical signals. Displays based on CRT and/or LCD technology cannot maintain the fidelity of the original x-ray film. Therefore many radiologists are opposed to making diagnoses from digital x-rays when their innate gestalt impressions are compromised by the display.

Light Boxes, CRT and LCD monitors, and laser projectors, are some existing display technologies. Below we discuss some of the desired requirements for some applications that can be addressed with the technology being presented herein.

Light Box:

To change the picture of a light box, the picture, such as a paper picture, is physically removed and replaced with another paper picture. It would be desirable to change a picture without physical removal and replacement of a printed picture.

CRT and LCD Monitors:

Many CRTs have limited brightness, physical size, and spatial resolution. Some of the brightest CRT displays are measured at about 60 foot-lamberts increasing to about 100 foot-lamberts for an advanced LCD display. The physical size of many CRT or LCD monitors is less than two feet diagonal. High resolution CRT displays are typically limited to about 1K by 1K pixels, with advanced LCD displays approaching 2K by 2K. It would be desirable to have improved brightness, resolution, and/or pixel count. It would also be desirable for a display to not lose picture information when power is lost or turned off.

Laser Display:

The laser display is quite expensive and complex. Additionally, the CRT, LCD, and laser display all lose picture information when power is turned off or lost. It would be desirable for a display to be less complex and/or less costly than a laser display. It would also be desirable for a display to not lose picture information when power is lost or turned off.

### SUMMARY

The technology being disclosed herein applies to the display of pictures. Some embodiments contain essentially unlimited spatial resolution. In addition, some embodiments of a display based on this technology will have the appeal of the high end laser displays in terms of the brightness and contrast. However, the complexity and physical appearance of some embodiments can resemble a light box. Because a light box cannot display a digital image directly, this new technology is referred to as the digital light box or DLB.

Displays based on DLB technology can provide commercial customers with the full beauty of their digital pictures as well as a convenient means of showing the pictures.

DLB displays can become the display of choice for radiologists by providing physicians with the confidence that they are seeing the full performance inherent in the digital signal and typical of x-ray film.

Another application of DLB technology can provide advertisers with physically large high performance displays that are cylindrical, spherical, and/or flat.

In many embodiments, birefringent material with an optically recorded birefringence pattern representing the picture is placed between crossed polarizers. A beam passing through a polarizer becomes a polarized beam. After the polarized beam passes through the birefringent material, the optically recorded birefringence pattern representing the picture is converted into a polarization rotation pattern across the polarized beam. Then, after the polarized beam passes through another polarizer, the polarization rotation pattern across the polarized beam is converted into an intensity pattern across the polarized beam. In many embodiments, the intensity pattern across the polarized beam is converted into the picture, such as with a screen.

Many embodiments include a birefringence varying medium, one or more polarizers, a first beam source, and a screen. The birefringence varying medium can include at least intensity information of a picture. At least the intensity information can be recorded in the birefringence varying medium. The first beam source can create a first beam of light, which can be optically coupled to the polarizers and optically coupled to the birefringence varying medium. The screen can be optically coupled to the first beam of light. The screen can convert the first beam of light into the picture.

### BRIEF DESCRIPTION OF THE FIGURES

FIG. 1. shows one embodiment of a DLB display.

FIG. 2. shows one embodiment of recording picture information on birefringent material.

FIG. 3. shows one embodiment of recording with scanning.

FIG. 4. shows one an example of transmission of light through a birefringent media with crossed polarizers.

FIGS. 5.A. and 5.B. show further embodiments of a DLB display.

FIG. 6. shows an example of the transmission of the light through parallel polarizers.

FIG. 7. shows an example of transmission between parallel polarizers including the effect of a waveplate adding 35° of birefringence.

FIG. 8. shows an example of producing a color display with a diffusing screen

FIG. 9.A. shows an embodiment of a mask for the filter deposition process where the circles indicate the location of holes in the mask.

FIG. 9.B. showing an embodiment where the red filter was deposited through the mask.

FIG. 9.C. shows an embodiment where the green filter was deposited through the mask, and the mask was translated by one pixel position.

FIG. 9.D. shows an embodiment where the blue filter was deposited through the mask, and the mask was translated by another pixel position.

FIG. 10. shows an embodiment of a color display.

FIG. 11. shows an embodiment of the color control such as for the embodiment of FIG. 8.

FIG. 12. shows embodiments of a display of a picture on a curved surface such as a sphere or cylinder.

FIG. 13. shows a method embodiment of displaying a picture.

### DETAILED DESCRIPTION OF THE INVENTION

Many embodiments include a birefringent material. Some examples of birefringent optical recording media that can record birefringence patterns are: photoresist, photopolymer, chalcogenide, magneto-optic, photo-ferroelectric, photo-conductive/electro-optic, and photodichroic materials.

Concentrating on the magneto-optic materials: the following elements Fe, Co, Ni, Gd, and Dy and a variety of alloys of these and other elements, exhibit a special effect that permits a specimen to have a high degree of magnetic alignment. Some embodiments include suitable materials for magneto-optical recording formed from the combinations of the above elements forming compounds.

Typical magneto-optical recording media works in reflection, with small Kerr effect rotations of about 1°. By using optimized media in a film of greater thickness (up to 5 μm), greater than 45° rotations can be achieved in transmission. Such a thick film may be unsuitable for optical disk applications with typical spot sizes of 1 μm, as the thickness of the film cannot be greater than the spot size without degrading the resolution. However, for some embodiments, a pixel size of 50 μm or more, in a 5 μm thick film is acceptable.

Some embodiments use a magneto-optic medium at least partly based on the active material cobalt ferrite as described by J. W. D. Martens and W. L. Peeters, Philips Research Labs, in their article “Interference enhanced magneto-optic Kerr rotation of thin cobalt ferrite films” published in the SPIE Proceedings Volume 420 (incorporated by reference), Optical Storage Media, June 1983. Data in FIG. (3) of this Philips paper gives the calculated and experimental Faraday rotation of a CoFe₂O₄ thin film as a function of photon energy. A common high power diode laser operating at 1.5 eV (wavelength about 800 nm) can record a Faraday rotation of about +6 degrees per micron of thin film (single pass). The same pixel having been written by the diode laser is displayed with 2.6 eV (470 nm) LED light. The rotation produced by the 2.6 eV light according to the Philips FIG. (3) is −12 degrees per micron (single-pass). Therefore, for 45° of Faraday rotation (the direction of the rotation here is relative and can be either + or −), about 4 microns of film thickness is required in one embodiment.

The deposition of this film can be efficiently accomplished by spray pyrolysis. This fact may be especially useful for large area DLB displays.

The 45° rotation result does not rely on the interference enhancement reported in the above paper and elsewhere (for example: R. N. Gardner, et al, 3M Optical Storage Laboratory, “Characteristics of new high c/n m-o media” page 242, G. Connell, Xerox PARC, Magneto-optical recording (incorporated by reference) page 222. both in SPIE Proceedings, volume 420, Optical Storage Media, June 1983, and C. J. Robinson et al IBM Almaden Research Center, “Amorphous carbon dielectric coatings for m-o recording media” Topical Meeting On optical Data Storage (incorporated by reference), volume 10, March 1987, page 131). Other embodiments can use interference enhancement techniques.

For cobalt ferrite, a magnetic field of about 20,000 Oersteds is required in some embodiments to overcome the coercivity of the material so that a laser may write and erase pixels. Considerable reduction in this field is accomplished by adding terbium. Some embodiments include one or more TbCoFe mixtures which can reduce the magnetic induction to around 100 Oersteds or less.

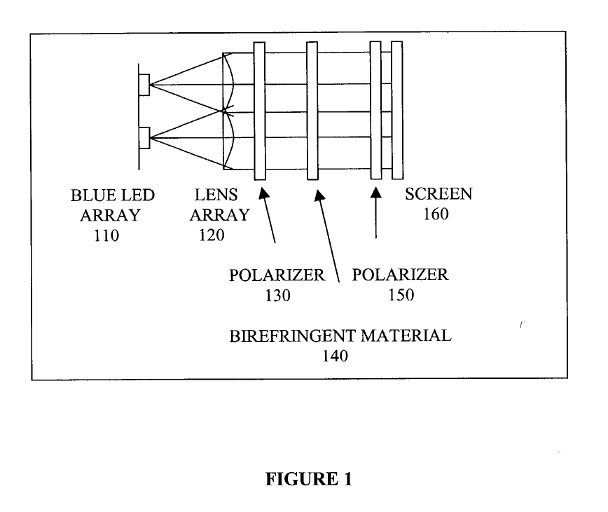

Some embodiments of the DLB use light for the display beam, such as blue light, to strike a screen, which may contain phosphors; similar to the idea of an electron beam striking a screen containing phosphors in a CRT display. The electron beam can be modulated in intensity by changing the current flow in the beam, thereby making a picture on the screen. Similarly the blue light can be modulated in intensity by situating a substrate with varying amounts of birefringence between crossed polarizers, thereby producing a picture on the screen. Optically coupled, such as by a beam, can mean transmission, reflection, absorption, and/or diffusion. The light source for the display beam may be either a combination of lasers, LEDs, filament lamps, or arc lamps. This is illustrated in FIG. 1, where the beam is optically coupled to the polarizers and birefringent material by transmission through these components and by striking a screen and hence absorption in the screen. Optically coupled may also mean that the light beam is reflected off a surface for instance a mirror. A beam may be optically coupled to a screen by striking the screen and hence resulting in the two processes of absorption in the screen and/or diffusion by the screen. When light of one color is absorbed by a phosphor in the screen it may be diffusely radiated as another color. Furthermore, while we refer to blue light, there are any number of possible colors of light as defined as an electromagnetic radiation, including visible wavelengths and/or wavelengths beyond the visible spectrum.

FIG. 1 shows one embodiment of the DLB display. Shown are a blue LED array 110, lens array 120, polarizer 130, birefringent material 140, polarizer 150, and screen 160. In one embodiment beam sources, such as the LED and lens arrays can be bonded together with a first polarizer to make the “light panel,” and the birefringent material, a second polarizer, and screen can be bonded together to make another assembly. The write and erase mechanism can be located in an air gap situated between these two assemblies. Some embodiments of the DLB are compact, lightweight, and/or rugged when compared to CRT technology.

The light panel can be based on an array of high power blue-emitting (about 470 nm each) AlGaInN LEDs. Each LED emits about 150 mW and must be mounted in a power dissipation packaged heat sink for some embodiments. Degradation of less than 20% initial light output is projected after 100,000 hours (“High-brightness AlGaInN light-emitting diodes” by LumiLEDs Lighting and Agilent Laboratories, Proceedings of the SPIE (incorporated by reference), vol. 3938, page 2, January, 2000). A 20 by 25 array of these elements, spaced over an 8″ by 10″ panel, provides 75 W of blue light. A lens array is used to improve the collimation of the rays, and the polarizer sheet transmits 40% or 30 W of polarized blue light from this panel.

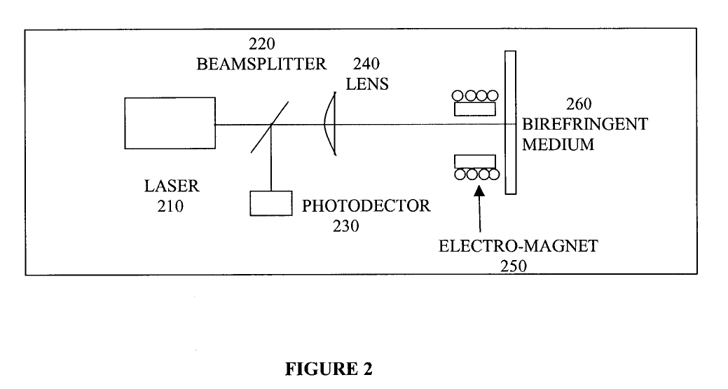

In order to write a pattern on the birefringent material a source of electromagnetic radiation, such as a laser, may be used in a layout such as a layout used in some optical disc recording devices. In one embodiment with birefringent material similar to that used in magneto-optic discs, the pattern may be written and erased on the birefringent material by using the concept shown in FIG. 2. The writing and/or erasing functions are called recording since the information is permanent (even with no power) until another recording operation, such as write and/or erase, is performed.

The picture is thereby recorded on the birefringent material using the optical power of the writing source to control the intensity; optics such as the lens to control the spot size, and/or the magnetic field direction to control whether the birefringence is increased in order to write each spot or decreased in order to erase each spot. The magnetic field strength may be constant during the optical recording process and/or may be varied during the optical recording process.

FIG. 2 shows a laser 210, a beamsplitter 220, a photodetector 230, a lens 240, electromagnet 250, and birefringent medium 260. In the embodiment shown in FIG. 2, the laser light strikes the birefringent material with a spot size determined by the lens. The direction of the induced birefringence (increasing or decreasing) is determined by the magnetic field direction and the amount of induced birefringence is determined by the intensity of the laser light. The reflected light returns towards the laser and is redirected to the photodiode so that the birefringence may be monitored and controlled.

A dichroic coating on the birefringent material, can be used in some embodiments, to reflect over 99% of the 800 nm reflected light back to the photodiode as shown in FIG. 2. This same coating can allow over 95% transmission of the blue display beam shown in FIG. 1., in this embodiment, to pass through the birefringent material and reach the phosphor screen.

In some embodiments, the picture to be recorded can be a digital, and/or analog, electronic signal, thereby allowing the display to change pictures electronically instead of physically.

Increasing the laser write power in response to the electronic signal, combined with a constant magnetic field, thereby inducing birefringence in the birefringent medium, controls the brightness of each pixel in the image recorded in the birefringent medium. In some embodiments, the relationship between the laser write power electronic signal and the transmitted pixel intensity may not be linear. Correction to a linear relationship can typically be applied by using a look up table, LUT, in the device driver. The LUT also takes into account variations in the display output so that a perfectly uniform illuminating light field is produced.

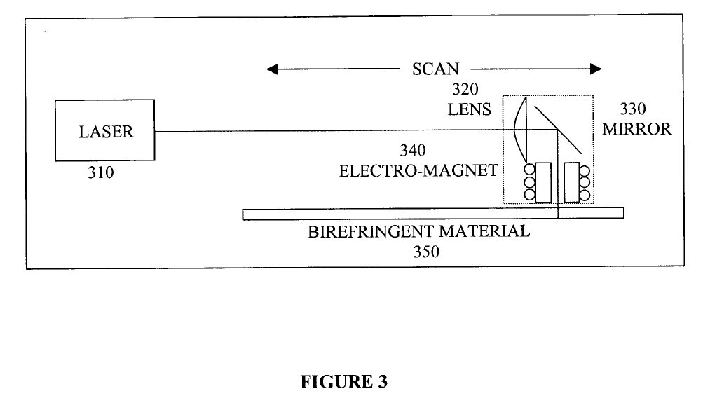

The single-channel scanning optical write-erase concept is shown in FIG. 3. FIG. 3 shows a laser 310, a lens 320, a mirror 330, an electromagnet 340, and birefringent material 350. Some embodiments are based on an economical 100 mW, 810 nm laser diode used in commercial optical disk players. In FIG. 3. the turning mirror and lens may be combined into a single off-axis spherical mirror. The beam is focused to a 50 μm pixel size using this off-axis spherical mirror. In some embodiments the lightweight mirror is rapidly scanned over the surface of the media. In addition to the mirror, an electromagnet is also positioned on the slider adjacent to the writing spot. The electromagnet produces a 100 Oersted field in an embodiment for writing on magneto-optical storage media and can be switched in polarity for erasing.

The writing velocity in what is referred to as the fat axis of the scan can be about 2 meters per second in one embodiment with a mechanical scanner similar in complexity to that of a laser printer. Typical writing velocities for optical disk drives are about ten times faster than this. Since the 5 μm thick films serving as the optical storage medium are correspondingly about ten times thicker than that of an optical disk, the same 810 nm writing laser can be used in some embodiments.

After each 120 ms fast-axis scan, the optical media can be translated by one pixel during the 40 ms turn-around time of the fast axis in a particular embodiment. Springs at each end of the slider axis aid in decelerating the slider and then accelerating it in the opposite direction so that very little energy is required by the fast-axis servo motor to reverse direction in an embodiment.

For the second direction, in another embodiment referred to as the slow axis scan direction, the laser can be mounted on the scan mechanism along with the slider for the fast axis; and this entire assembly is then translated.

In some embodiments, a number of mirrors and electromagnets, such as 16 mirrors and, electromagnets, can be mounted on a bar and mechanically scanned to write and erase, in an embodiment using 16 lasers, the 20 million pixel image in about 1 minute. The time to write one 24 cm high by 18 cm wide mammography image with 4,000 columns and 5,000 rows is estimated to be less than one minute. In some embodiments, the write and/or erase time is decreased further by increasing the number of lasers, mirrors and electromagnets.

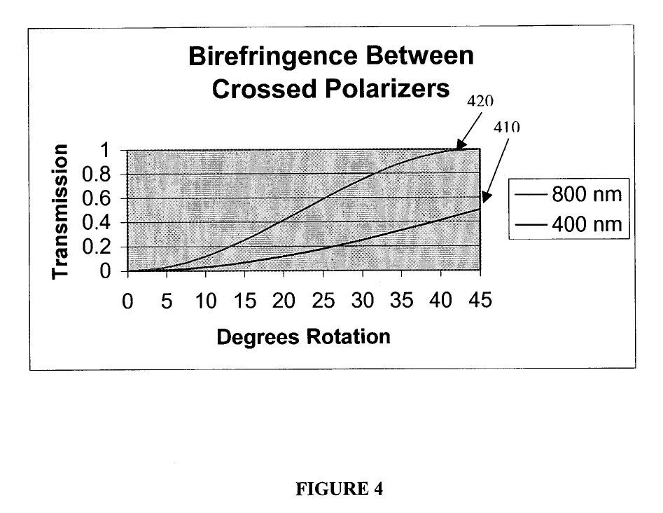

FIG. 4 shows two curves, an 800 nm curve 410 and a 400 nm curve 420. FIG. 4 shows that the amount of light that is transmitted through the combination of polarizer—birefringent medium—crossed polarizer, at each pixel depends on the amount of rotation of the polarization state in the birefringent medium at that pixel. In the shown embodiment, the transmission of light through a birefringent media with 45° of rotation recorded at 800 nm controls the intensity of 400 nm light from 0 (complete off state) to 1.0 (complete on state). In addition, if the rotation pattern is written at one wavelength, say 800 nm and displayed at another wavelength, say 400 nm, then there will be twice the rotation at 400 nm compared to 800 nm. Therefore the transmitted signal at 400 nm will be greater than the transmitted signal at 800 nm as shown in the FIG. 4. Other embodiments use different wavelengths, and/or different ratios between the wavelength used to write the pattern and the wavelength used to display the pattern.

While we refer to 400 nm light as blue light, and 800 nm light as laser light above, there are any number of possible colors of light that could be used where the color is defined by spectral content of the constituent waves of electromagnetic radiation.

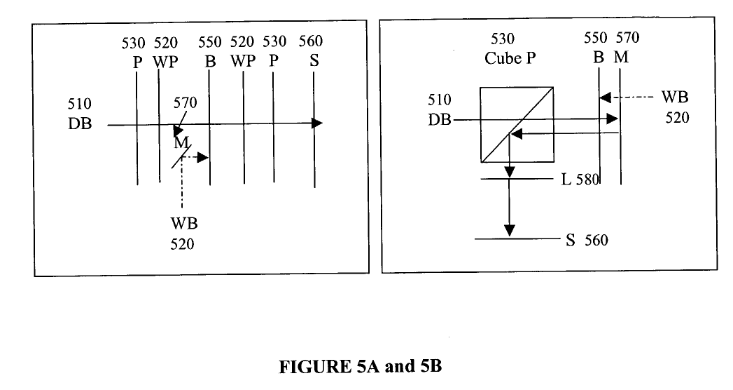

FIGS. 5.A and 5.B show further embodiments of a DLB display. The solid line represents the display beam (DB) 510, and the dashed arrow the write beam (WB) 520. Other components are polarizer (P) 530, wave plate (WP) 540, birefringent material (B) 550, screen (S) 560, mirror (M) 570, and lens (L) 580. The cube polarizer may also be a plate polarizer beam-splitter. Although difficulties can be presented if the write beam is located “in the way of” the display beam, the write beam may or may not be included in various embodiments.

In some embodiments, the polarizers in FIG. 5.A, are oriented parallel to each other, and wave plates are used to generate polarizations, for example, circular or elliptical polarizations, that interact with the birefringent material. Having passed through the birefringent material, the optically recorded birefringence pattern representing a picture is converted into a polarization rotation pattern across a polarized beam. Then, having passed through another polarizer, the polarization rotation pattern across the polarized beam is converted into an intensity pattern across the polarized beam.

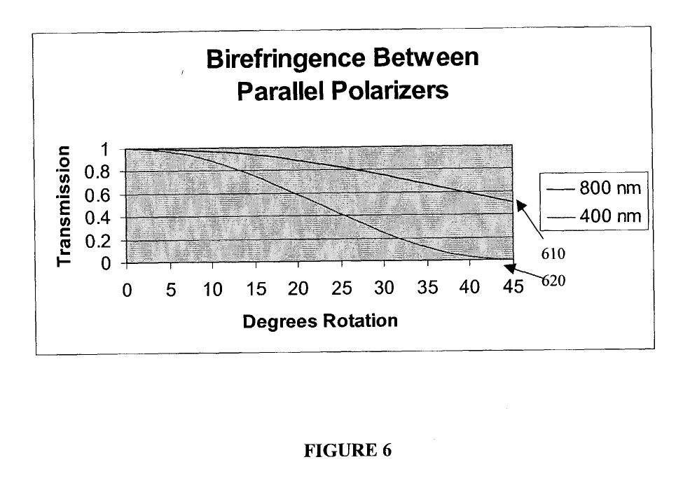

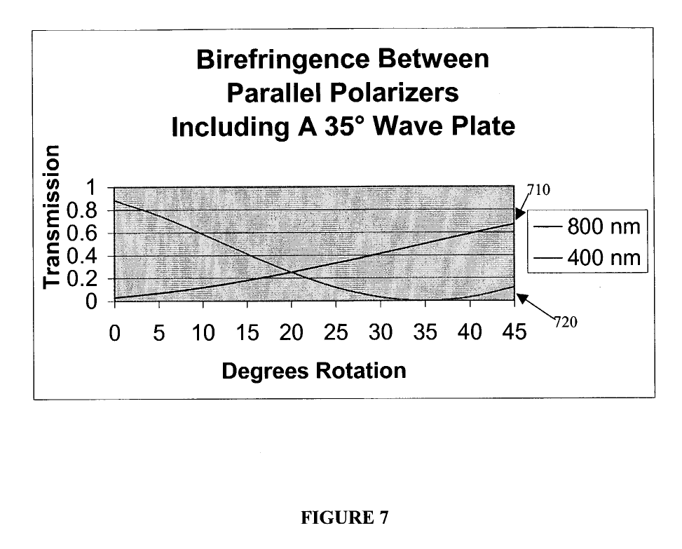

Thereby the transmitted beam brightness, shown in FIG. 6, from the second polarizer, may be changed to a different function of the rotation angle for example as shown in FIG. 6. FIG. 6 shows two curves, an 800 nm curve 610 and a 400 nm curve 620. In this case the “off” and “on” states are reversed and no wave plates are used. When wave plates are used, the transmitted beam brightness, shown in FIG. 6 changes so that the “off” and “on” states are no longer at zero and 45 degree positions of the birefringence rotation. The new brightness as a function of the rotation angle is presented in FIG. 7.

FIG. 7 shows two curves, an 800 nm curve 710 and a 400 nm curve 720. In FIG. 7, the transmission between parallel polarizers including the effect of a wave plate adding 35° of birefringence is shown. The advantage of this addition in complexity in the optical configuration is that the transmission state of the 400 nm light goes from a maximum at zero degrees of birefringence in the birefringent material, to a minimum at 35° of rotation in the birefringent material. Therefore less birefringence in the birefringent material is required in one embodiment to produce the maximum contrast in the picture. The 10% loss in transmission of the maximum value can be made up, to first approximation, by increasing the power in the display beam by 10%.

As shown in the optical configuration FIG. 5B, the advantages of this embodiment can be at least two fold. One, that the display beam makes two passes through the birefringence material thereby reducing by half the amount of induced birefringence required. Two, that one polarizer (the cube) is used for both of the functions of the two polarizers above, and the location of the writing beam or beams may be “out of the way” of the display beams.

One embodiment solves the problem of the location of the write beam in FIG. 5A and may also solve this problem in other embodiments, with a separate apparatus dedicated to the writing beam function. A substrate with the birefringent material is first written in the separate apparatus and then the substrate is moved to the apparatus containing the display beam and positioned to the appropriate location to properly display the picture. Other embodiments include both a writing apparatus and a display apparatus.

Because beams of light tend to spread as they propagate, the picture on the screen may tend to appear out of focus if the screen is located in a position not adjacent to the birefringent material. To remedy this situation as shown in FIG. 5.B., a lens may be required to focus an image of the birefringent material on the screen. Note that this lens may not be required in the embodiments shown in FIGS. 1., and 5.A., because the birefringent material may be located immediately adjacent to the screen.

Two exemplary displays are a monochrome, and a full color display. In some embodiments, the main difference is in the screen.

At the screen, the intensity pattern across the polarized beam is converted into the picture. Many screens contain phosphors to accomplish this. Some screens rely on diffusion. The screen can provide a location for the picture such that it can be seen by, for example, the human eye, or a camera, such as a television camera.

Some embodiments of the screen are coated with a yttrium aluminum garnet, Y₃Al₅O₁₂, phosphor that both absorbs and diffuses, in this embodiment, the blue LED light and emits a diffuse wide-angle soft blue-white light. Addition of cerium to the YAG controls the color rendering index, and provides efficiencies of blue to white light power conversion of about 60% (the luminous efficiencies are over 100% because the eye is more sensitive to the white light) as described in “White light-emitting diodes for illumination” by Agilent Technologies, SPIE Proceedings (incorporated by reference) Volume 3938, January, 2000, page 30. Some embodiments use a dichroic film that allows the blue light to enter the phosphor and reflect the backward-emitted white light forward into the displayed image.

Anti-reflection coatings and pixellation techniques can reduce the glare from the display apparatus. This glare can be caused by ambient light outside the display apparatus, and can limit the minimum display intensity and hence the contrast. The actual minimum image intensity, such as with no ambient glare, viewed through the crossed polarizers is over three hundred times less than the “on” state display intensity.

The total emitted power density for the screen operating in maximum brightness mode is about 10 W of soft blue-white light spread over the 18 cm by 24 cm display, in some embodiments where the 30 W polarized blue light panel (described above) is used. Users of this type of monochrome display, such as radiologists, can find this sufficient illumination and contrast for applications such as the mammography application.

Some embodiments of the DLB have a brightness in the 200 to 300 foot-lambert range. Some embodiments of the DLB can be essentially unlimited in the size of the display. Some embodiments of the DLB can be essentially unlimited in the number of pixels.

A color picture is made in a standard way by using three phosphors emitting red, green and blue (RGB) light. Each single line in the picture now consists of RGB pixels in the repeating pattern: RGBRGBRGB . . . . This is similar to the technique used in color CRT displays. In some embodiments, the blue LED light is used to stimulate the phosphors. Some embodiments use RGB phosphors described in detail in “White light-emitting diodes for illumination” by Agilent Technologies, SPIE Proceedings (incorporated by reference) Volume 3938, January, 2000, page 30.

Two other embodiments for making a color display are described below based on a diffusive screen. Phosphors are thereby rendered optional.

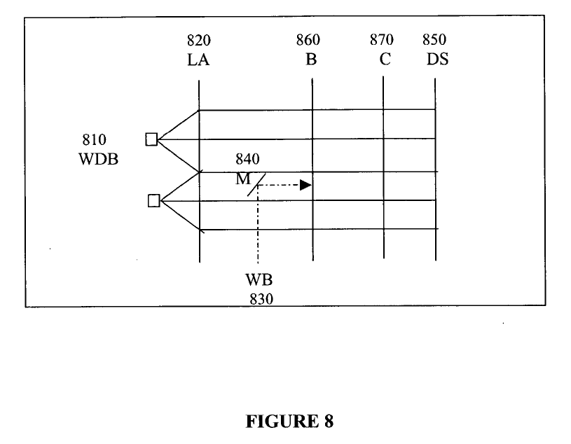

FIG. 8. shows an example of producing a color display with a diffusing screen. The components are a light panel producing a white display beam (WDB) 810, a lens array (LA) 820, a write beam (WB) 830, a mirror (M) 840, a diffusing screen (DS) 850, a brightness control (B) 860, and a color control (C) 870. The detailed optical design of the white display beam for some embodiments is given in “LED Backlight: Design, Fabrication and Testing” by Brown et. al. presented at the SPIE Conference on Light-Emitting Diodes: Research, Manufacturing, and Applications IV, January 2000 in San Jose (incorporated by reference). The light source for the WDB may be either a combination of red, green and blue LEDs, or lasers, or white LEDs, or filament lamps, or arc lamps.

The brightness control (B) in the embodiment of FIG. 8. may be a birefringence medium optically coupled to two polarizers so that the write beam (WB) may create the picture by recording on the birefringent material as mentioned above and illustrated in FIG. 1. Locations of individual spots forming the pixel locations are determined by the locations of the color control, (C), pixels. In this embodiment, the color of each pixel location can have the beam color of that pixel. Therefore the amount of rotation determining the brightness of the pixel can be that of red, green or blue light. More rotation for green and red can be required as compared to the rotation for blue; in order to produce the same contrast in the picture for each color.

The color control, (C), in the embodiment of FIG. 8., may use the transmission properties of white light through color filters, for some embodiments, as described in “Wide-Bandwidth Transmission Interference Filters”, Handbook of Optics 1978 (incorporated by reference), page 8-85 paragraph 82. The all-dielectric films are deposited on a substrate through a mask that determines the location of the pixel spots.

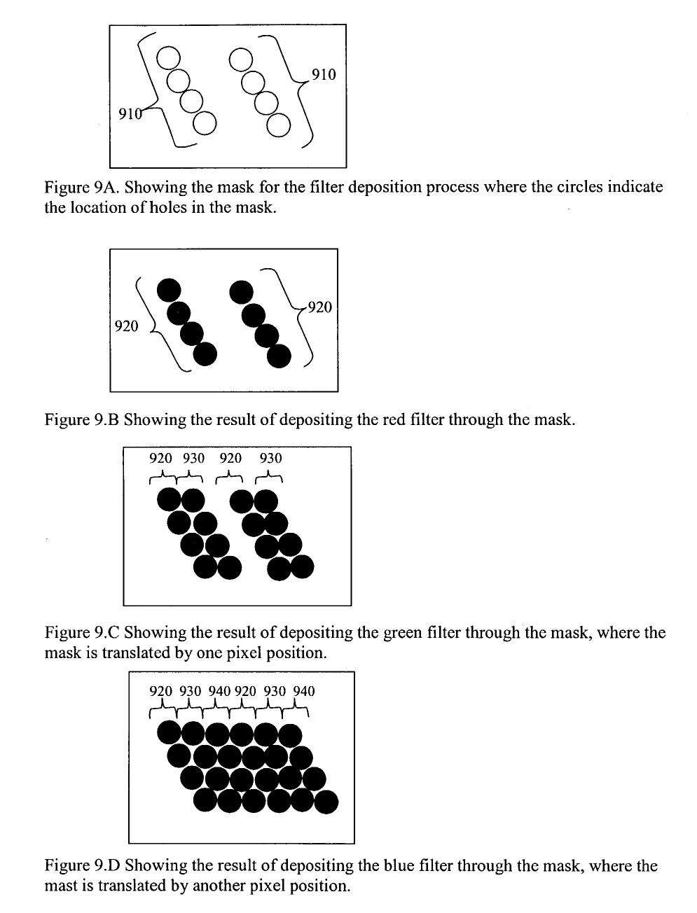

FIG. 9.A. to D. shows this, where the mask is translated to each of three locations to produce the array of RGB pixels. FIG. 9A. shows the mask for the filter deposition process where the circles 910 indicate the location of holes in the mask. FIG. 9.B, with red pixels 920, shows the result of depositing the red filter through the mask. FIG. 9.C, with green pixels 930, shows the result of depositing the green filter through the mask, where the mask is translated by one pixel position. FIG. 9.D, with blue pixels 940, shows the result of depositing the blue filter through the mask, where the mask is translated by another pixel position.

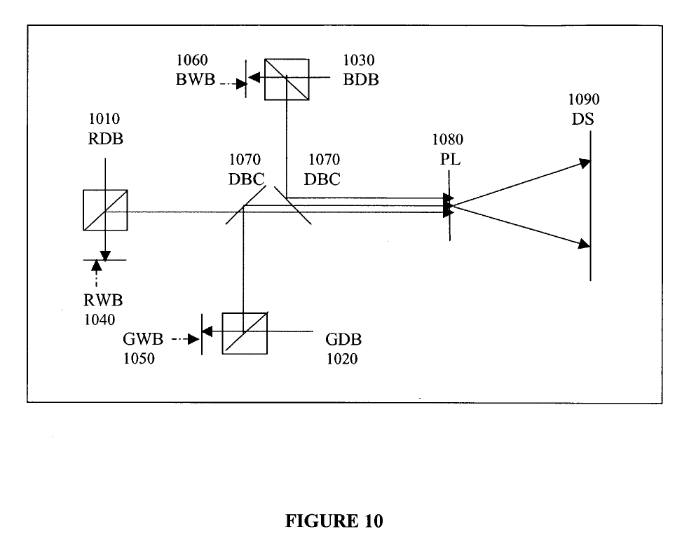

A second embodiment for making a color display using a diffusing screen is shown in FIG. 10. Three birefringent media with RGB beams are combined into one beam with dichroic beam combiners (DBC) 1070. Red, green, and blue display beams are (RDB 1010, GDB 1020, and BDB 1030) and these beams may be produced by LEDs, lasers, arc lamps and filament lamps in separate embodiments, and red, green, and blue write beams are (RWB 1040, GWB 1050, and BWB 1060) and these beams may be produced by LEDs, lasers, arc lamps and filament lamps in separate embodiments. Some embodiments can also be based on the configuration shown in FIG. 5.A. and/or FIG. 5.B Also shown are the projection lens (PL) 1080 and the diffusive screen (DS) 1090. The projection lens (PL) is used to image each of the three birefringent media onto a diffusive screen (DS).

The color control, (C), in the embodiment of FIG. 8., may also use the transmission properties of white light through polarization interference filters, for some embodiments, as described in “The Lyot-Ohman Filter”, Handbook of Optics (incorporated by reference) 1978, page 8-111 paragraph 109.

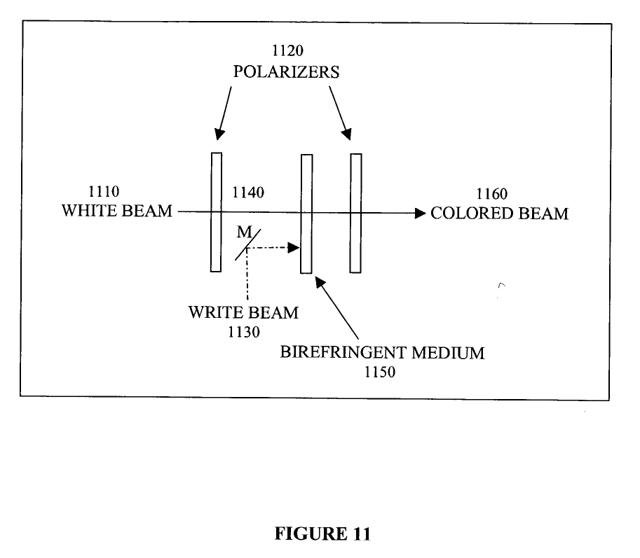

FIG. 11 shows an example of a color control element (C), such as for the embodiment shown in FIG. 8. FIG. 11 shows white beam 1110, polarizers 1120, write beam 1130, mirror (M) 1140, birefringent medium 1150, and colored beam 1160. This embodiment can be a simple Lyot-Ohman filter, such as a birefringent element situated between a pair of polarizers or it can be a more complicated Lyot-Ohman filter, such as a combination of birefringent elements situated between pairs of polarizers as described in the above reference Handbook. A white display beam passing through the pair of polarizers and birefringent material produces a colored beam. The color of the transmitted beam can be determined by the amount of birefringence rotation in the birefringent material. The color at each pixel location may thereby be determined by the write beam, such as the recording beam described in FIG. 2, that records a birefringence rotation at that pixel location.

The birefringent material may have the color determining pattern recorded in the apparatus itself as shown in FIG. 8., or a separate apparatus may be used to record the color determining pattern.

Four main specifications for a display are size, brightness, resolution and contrast. The size and resolution for some embodiments of the DLB display are essentially unlimited, with the size determined by the manufacturing process and the resolution determined by the diffraction limit of light. The brightness is determined by the power and number of light sources, such as blue LEDs. 300 foot lamberts over an 8″ by 10″ screen, may be readily obtained by a practical number of commercial LEDs. The contrast can be determined by the ratio of transmission to extinction properties of the polarizer(s) and can be greater than 300 to 1 for commercially available plastic film polarizer(s).

While some embodiments display pictures that are flat, there are embodiments of the DLB technology that allow curved surfaces such as the inside or outside of a spherical or cylindrical surface to be built, allowing the display of pictures that are not flat, such as curved pictures. Pictures can also be at least partly curved and/or at least partly flat. The factors that determine the surface shape are the manufacturing processes of the glass, plastic, and/or other substrates that allow the light panel, the birefringent material and polarizers, and the screen to be fabricated into spherical or cylindrical shapes. In one embodiment, the scanning mechanism for the optical recording beam can follow a curved track, and/or a straight track.

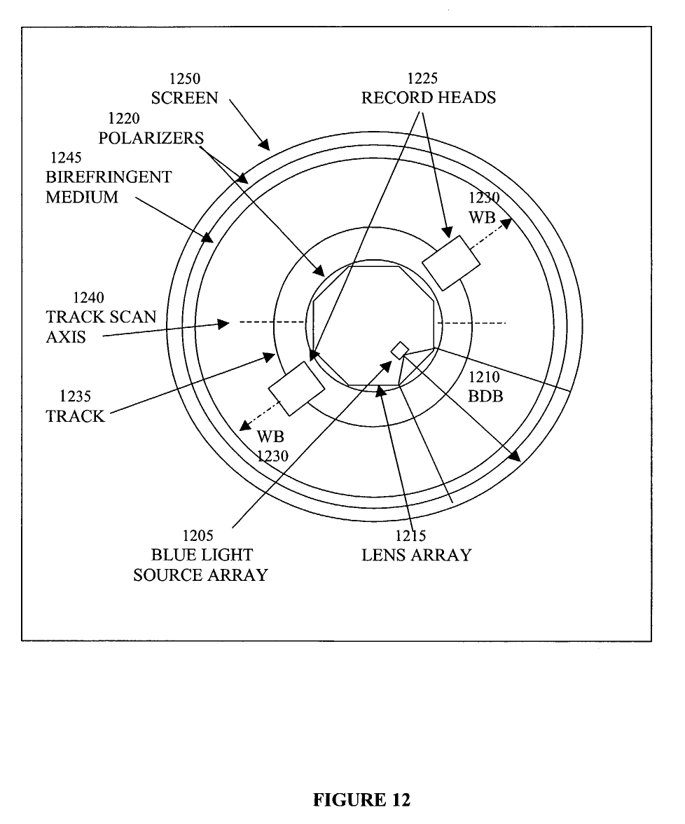

The design shown in FIG. 12. applies to both a spherical surface in one embodiment and a cylindrical surface in another embodiment. The track can be a circular track in both embodiments. FIG. 12 shows blue light source array 1205, blue display beam (BDB) 1210, lens array 1215, polarizers 1220, record heads 1225, write beams 1230, track 1235, track scan axis 1240, birefringent medium 1245, and screen 1250.

For the spherical embodiment, the screen, polarizers and birefringent medium are fabricated in hemispherical dome shapes and combined to form the concentric spherical shapes. The display beam, for example a blue display beam, is composed of light sources, for example LEDs, and lenses, that are arranged in a regular polyhedra solid geometry, thereby uniformly illuminating most of the inside spherical surface of the screen with the blue display beams (BDBs). The scanning track axis can form the axis of rotation of the mechanism that rotates the track, thereby allowing the write beam (WB) to record over most of the inside spherical surface of the screen.

For the cylindrical embodiment, the screen, polarizers, and birefringent medium are fabricated in cylinder shapes and combined to form the concentric cylindrical shapes. The display beam, for example a blue display beam, is composed of light sources, for example LEDs, and lenses, that are arranged in a regular octogon, or other regular shape geometry, thereby uniformly illuminating most of the inside cylindrical surface of the screen with the blue display beams (BDBs). The scanning track axis can form the axis of translation of the mechanism that translates the track, thereby allowing the write beam (WB) to record over most of the inside cylindrical surface of the screen.

For some commercial applications it would be convenient to have the display independent from the computer, for example a picture hanging on a wall or an electronic billboard. Some embodiments of the DLB can be loaded with a picture by, for example, a memory card or a wire, or a wireless connection, from a computer, and once the picture is written, the card or wire is no longer required. The picture can be turned on or off but the display can retain the picture information without the need to reload the electronic information.

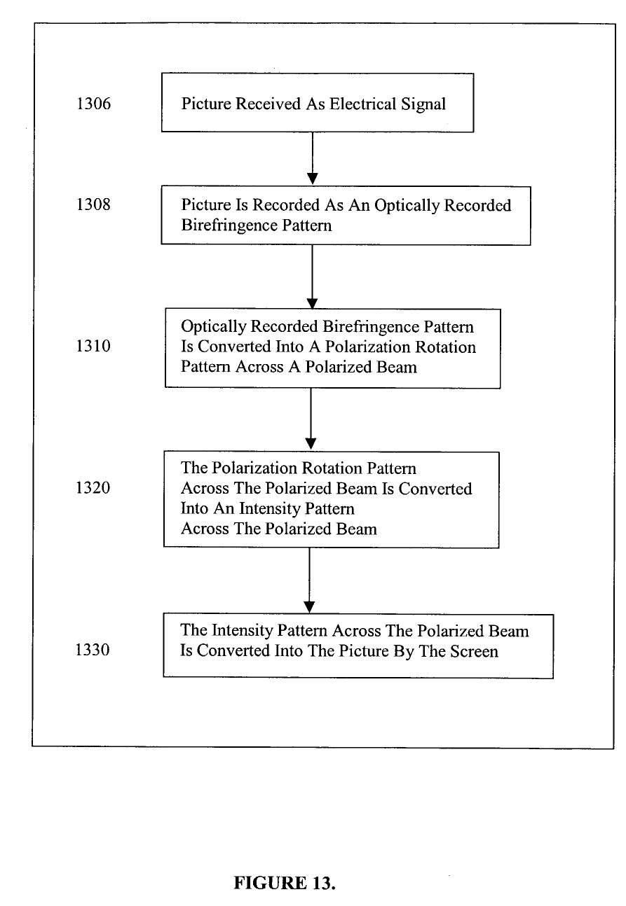

FIG. 13 shows one embodiment of a method 1300. In 1306, a picture (to be recorded as an optically recorded birefringence pattern representing the picture) is received, for example as an electrical signal. In 1308, a picture is recorded as an optically recorded birefringence pattern representing the picture. In 1310, the optically recorded birefringence pattern representing a picture is converted into a polarization rotation pattern across a polarized beam. In 1320, the polarization rotation pattern across the polarized beam is converted into an intensity pattern across the polarized beam. In 1330, the intensity pattern across the polarized beam is converted into the picture by the screen. Various embodiments add, delete, modify, and/or rearrange these steps.

What is claimed is:

1. A method of picture display from an electronic signal, comprising:
converting at least one optically recorded birefringence pattern representing a picture into at least one polarization rotation pattern across at least one polarized beam;
converting at least one polarization rotation pattern across at least one polarized beam into at least one intensity pattern across at least one polarized beam; and
converting at least one intensity pattern across at least one polarized beam into the picture.

2. The method of claim 1, further comprising:
recording the picture as at least one optically recorded birefringence pattern representing the picture.

3. The method of claim 2, wherein recording the picture includes determining a direction of induced birefringence at least partly via a direction of a magnetic field.

4. The method of claim 2, wherein recording the picture includes determining a magnitude of induced birefringence at least partly via a beam intensity.

5. The method of claim 1, further comprising:
receiving, as an electrical signal, the picture recorded as at least one optically recorded birefringence pattern representing the picture.

6. The method of claim 1, wherein:
converting at least one optically recorded birefringence pattern representing a picture into at least one polarization rotation pattern across at least one polarized beam includes:
converting at least two optically recorded birefringence patterns representing a picture into at least two polarization rotation patterns across at least two polarized beams; and
converting at least one polarization rotation pattern across at least one polarized beam into at least one intensity pattern across at least one polarized beam includes:
converting at least two polarization rotation patterns across at least two polarized beams into at least two intensity patterns across at least two polarized beams.

7. The method of claim 6, further comprising:
combining at least two polarized beams into at least one polarized beam.

8. A picture display apparatus comprising:
a birefringence varying medium
including at least intensity information of a picture, at least the intensity information being recorded in the birefringence varying medium, one or more polarizers;
a first beam source creating a first beam of light
optically coupled to the one or more polarizers and
optically coupled to the birefringence varying medium; and
a screen optically coupled to the first beam of light,
wherein the screen converts the first beam of light into the picture.

9. The method of claim 8, further comprising:
a second beam source creating a second beam of light
optically coupled to the birefringence varying medium,
wherein the second beam of light at least partly causes recording of at least the intensity information recorded in the birefringence varying medium.

10. The method of claim 9, further comprising:
an electromagnet generating a magnetic field
magnetically coupled to the birefringence varying medium,
wherein the magnetic field at least partly causes recording of the picture recorded in the birefringence varying medium.

11. The method of claim 8, further comprising:
one or more wave plates optically coupled to the first beam of light.

12. The method of claim 8, wherein the one or more polarizers comprises:
one or more polarizing beam splitters.

13. The method of claim 8, wherein the birefringence varying medium, the one or more polarizers, and the screen are flat.

14. The method of claim 8, wherein the birefringence varying medium, the one or more polarizers, and the screen are cylindrical.

15. The method of claim 8, wherein the birefringence varying medium, the one or more polarizers, and the screen are spherical.

16. The method of claim 8, wherein the birefringence varying medium, the one or more polarizers, and the screen are at least partly flat.

17. The method of claim 8, wherein the birefringence varying medium, the one or more polarizers, and the screen are at least partly cylindrical.

18. The method of claim 9, wherein the birefringence varying medium, the one or more polarizers, and the screen are at least partly spherical.

19. The method of claim 9, wherein the screen includes phosphors.

20. The method of claim 9, further comprising:
a second birefringence varying medium
including at least color information of the picture, at least the color information being recorded in the second birefringence varying medium.

21. The method of claim 20, further comprising:
a third beam source creating a third beam of light
optically coupled to the second birefringence varying medium,
wherein the third beam of light at least partly causes recording of at least the color information recorded in the second birefringence varying medium.

22. A picture display apparatus comprising:
two or more birefringence media,
including a picture recorded into each of the two or more birefringence media;
one or more polarizers;
two or more beam sources creating beams of light,
each optically coupled to at least one of the one or more polarizers,
each optically coupled to at least one of the two or more birefringence media;
a beam combiner combining beam of light into a combined beam of light; and
a screen,
optically coupled to the combined beam of light,
wherein the screen converts the combined beam of light into the picture.

23. The method of claim 22, further comprising:
a lens,
optically coupled to the combined beam of light, and
optically coupled to the screen.
